(19) United States
(12) Patent Application Publication
(10) Pub. No.: US 2002/0147794 A1
(43) Pub. Date: Oct. 10, 2002

(54) Service allocation and assigning method and program therefor

(76) Inventor: Guy Middleton, Stonehaven Barn (GB)

Correspondence Address: HIGGS, FLETCHER & MACK LLP, 2600 FIRST NATIONAL BANK BUILDING, 401 WEST "A" STREET, SAN DIEGO, CA, 92101-7910, US

(21) Appl. No.: 10/084,883

(22) Filed: Feb. 27, 2002

(30) Foreign Application Priority Data
Feb. 28, 2001 (GB) 0104933.7

(51) Int. Cl. G06F 15/16

(52) U.S. Cl. 709/219; 709/206; 709/218

(57) ABSTRACT

Service Allocation and Assigning Method and Program therefor A computer sever-based process for matching users of a messaging system requiring a particular service to those users of the same messaging system who have identified themselves as being capable of providing such a service is described. Practically, a messaging service provider (MSP) provides a messaging server connected to the internet on which calendaring functions are offered to users of the MSP in the wider internet community. The users requiring a service create an item in the messaging system including descriptive textual information concerning the service required and one or more proposed times and dates when that service would ideally be required. In accordance with the invention, those users of the MSP wanting to offer services also create items including descriptive textual information concerning the service provided and a plurality of times when said service is capable of being provided, whereafter a routine is executed which effects the following:

a query string is derived from the textual and time and date information entered by the user requiring a service

said query string is used to query the messaging system database to extract relevant records identifying users offering a service of the type described and available at the relevant time and date

the information retrieved from the database is returned to the user requiring a service with information identifying the said users offering said service.

This invention relates to a method of allocating and assigning services such as those which may be offered by trades persons within a community, and more specifically to a means for matching the entries made in the computer diary of one person with those of another.

Although the following description is provided with almost exclusive reference to the use of electronic diaries hosted on remote server computers directly connected to the internet and the use of those diaries by persons both requesting and offering services, goods, resources and the like by connecting remotely over the internet to such servers, it is to be appreciated that the invention should not be considered as limited by this particular configuration. Indeed it is foreseen by the applicant that the invention may be applied within an organisation having a client/server type network whose servers run software capable of providing scheduling and calendaring services to local or remote users connected to the organisation network, or indeed any type of computer network.

The reader will instantly appreciate that at the time of filing of this application, the numbers of people having the capability of accessing the internet whether at home or in work is continuing to grow explosively. In particular, although scheduling and calendaring services are commonly provided on a LAN (local area network) to those within offices and other corporations, the use of these services from the home is currently limited. For instance, corporate networks such as LANs and WANs typically have significantly greater bandwidth than can be obtained by use of a modem to connect to an Internet Service Provider (ISP) and while scheduling and calendaring information can be transferred substantially instantaneously over a LAN, the transfer of such information over a conventional Internet dial-up connection is typically quite slow. The transfer of information is of course approximately constant once a dial-up connection has been made, but home users tend to use the bandwidth available on making the connection to download information using HTTP by which HTML or other coded web pages can be transferred from one computer to another, FTP which allows the downloading of individual or multiple computer files, and SMTP which allows the transfer of e-mail messages between two computers.

Home users who require calendaring and scheduling functions will typically use an e-mail package such as Microsoft® Outlook, Outlook Express, Lotus® Notes and the like in which such functions are integrated, but which typically only operate to transfer e-mail and other SMTP messages between the local machine and the remote ISP server, which then forwards such messages to the intended recipient over the internet. Alternately, when the remote connection is made directly to a corporate server, or when the computer on which such packages are operating is connected over a LAN to the corporate server, the user can use the calendaring and scheduling functions of the package to make diary entries with suitable reminders, arrange meetings, create task lists, make notes and view journal entries for various operations, as well as receiving and sending conventional e-mail messages. In the corporate environment, a server-based messaging package will typically be employed, such as for example Microsoft® Exchange Server or Lotus® Notes Server which manage each and every individual item created, sent, deleted, saved or received by any user having an account on both the network and within the messaging software.

The messaging software stores the items for all users having an account in a server database, and it is one of the primary functions of the messaging software to effectively and efficiently store information to and retrieve information from this database. It will be appreciated that in a large corporate organisation with many hundreds of users being provided with messaging services on their local computers, this database can become very large.

In the context of the wider internet, ISPs and Messaging Service Providers (MSPs), being those service providers who allow people having an internet connection to set up a personal and private e-mail account which can be accessed using a simple internet browser program as opposed to any proprietary messaging software, have begun offering calendaring services in a similar manner to that in which they are provided on a corporate network. Specifically, a remote user will complete a dial up connection to the internet and access the web site of an MSP, and after entering identification information and a password, can selectively view lists of so-called items, which generic term will be used hereinafter to refer to any entry in the server-based messaging software database. Items will typically be manifested in a single record in the messaging software database and consist of a variety of different types of information such as dates and times of creation, receipt or deletion, details of the creator or sender of the item, the duration where the item is an appointment, and other information commonly associated with such items.

Items can of course include traditional e-mail messages and any attached files sent therewith, but items in general include appointments, tasks, frequently used contact details and the like. Once entered and stored, received, sent, or otherwise created, any item can be viewed by the remote user as an HTML or like language page in the browser program. The various operations which can be effected on such items such as deletion, forwarding, moving and updating can be performed by clicking links presented to the user on the web page which will typically be created dynamically depending on the number of items of a particular type shown on a particular page.

Certain MSP also allow for reminder items to be entered which can automatically remind a user of a forthcoming date immediately that user logs into the MSP system. Indeed, in creating a new appointment on certain MSPs web-sites offering calendaring services to users, a large amount of information can be entered, such as a description, the category of the appointment (e.g. personal, holiday, meeting, anniversary or birthday dates etc.), the location, start and finish date and time, the frequency or repeating nature of the appointment, reminder information, comments, relevant telephone numbers, e-mail addresses, and internet address, and perhaps of most relevance to this description of prior techniques, it is possible to invite attendees to the appointment by entering particular e-mail addresses of those persons it is desired to invite.

Once entered, all this information is stored in the database and in the instance where attendees are invited, e-mails are automatically sent by the MSP, and more particularly by the server-based messaging software, to those persons invited. These persons will typically respond either confirming their attendance at the appointment or indicating that they cannot attend whereupon the user will have to re-arrange the meeting.

In the corporate environment, the creation of appointment items and the invitation of various attendees is usually significantly quicker as many of the attendees may also be part of that corporation and will receive relevant requests over the LAN very quickly. Indeed, within Microsoft® Outlook it is already possible, provided that user privileges and access rights have been suitably configured, to inspect the calendars of colleagues, at least as far as establishing whether a particular colleague has an appointment previously arranged on a particular day or at a particular time. It may also be possible to determine further details such as location, time and a description of the appointment.

The fundamental disadvantage with this type of inter-communication is that the colleague or other invitee must actively respond to requests for attendance at a particular appointment occasioned by the creation of an appointment item by another user or colleague. This is the case regardless of whether messaging services are being used in a corporate environment or over the wider internet using an MSP.

It is an object of this invention to marry one of the most common uses of the internet which is the requisitioning of services and goods with the arranging of appointments.

According to the invention there is provided a computer sever-based process for matching users of a messaging system requiring a particular service to those users of the same messaging system who have identified themselves as being capable of providing such a service, said users requiring a service being required to create an item in the messaging system including descriptive textual information concerning the service required and one or more proposed times and dates when that service would ideally be required, said service providers being required to create items including descriptive textual information concerning the service provided and a plurality of times when said service is capable of being provided, characterised in that the process includes the steps of

deriving a query string from the textual and time and date information entered by the user requiring a service

using said query string to query the messaging system database to extract relevant records identifying users offering a service of the type described and available at the relevant time and date

automatically returning the information retrieved from the database to the user requiring a service with information identifying the said users offering said service.

Preferably the messaging system is provided on one or more servers of a MSP, and the creation of items by users both requiring and offering a service is effected over a remote dial-up connection to said MSP.

Preferably the items created by users are appointment items which automatically require a selection to be made by the user of the relevant start and end times and dates of the particular appointment.

Most preferably, users creating appointment items using the system are required to make a selection of whether a service is being sought or offered before the appointment item is created in the MSP messaging system database.

It is yet further preferable that the query is performed on a subset of the messaging system database wherein said subset is defined by the criterion of appointments which relate only to the supply of services.

Examples of further criteria which could be included in the derived query, and which would therefore further limit the number of records revealed could include, date time, cost, location, gender, age, common interests and the like.

Preferably the query is derived and conducted on the underlying system database immediately on creation of the appointment item, and information retrieved by said query is displayed on a subsequently dynamically created HTML or like language page.

In one embodiment, the appointment item indicating the type of service required and ideal times therefor is created on, and information identifying users offering a service is returned to a mobile telecommunications device such as a mobile telephone having a calendaring function programmatically or otherwise provided thereon and capable of transmitting and receiving information to and from a computer network using SMS (Short Message Service), WAP (Wireless Application Protocol), iMODE, mobile PDAs (Personal Diary Assistant) or Electronic Personal Organisers having telecommunications capability and the like.

Preferably the mobile telecommunications device is capable of communicating directly with the MSP on which the service according to the invention is executing, and in one interpretation, such a device effectively amounts to no more than a computer having a network or internet connection to the server computer or computers of the MSP.

A specific embodiment of the invention will now be described by way of example.

Users of the internet will be aware of MSP such as Hotmail® and Yahoo® which provide the facility for keeping an on-line diary with a potentially unlimited number of appointments over a very long period of time, perhaps of the order of many years. Indeed, within Microsoft® Outlook the calendar extends well over 100 years into the future.

As mentioned above, this invention is ideally suited to calendaring services provided by MSP, but the process could be equally applied within the corporate environment wherein the creation of appointment automatically initiated a search of each and every appointment item previously created indicating the availability of a particular colleague providing the required service.

In the context of MSPs however, a user will provide textual information such as the service required and the ideal dates and times, for example “painter, 15:30 02-02-2001 to 17:30 02-02-2001”. The user will additionally be required to click an option button indicating to the MSP whether this appointment indicates a request for a particular service to be provided or an offer to provide that service.

The program implementing the invention will typically reside on the same server as the messaging system software and run in parallel therewith so that on instructing the messaging system to save the relevant details of the appointment in the messaging system database, the implementing program will be furnished with the relevant information, dynamically derive the query string and query the database with the string to extract relevant matching records which can then be dynamically displayed on an HTML or like language page in the browser in use by the remote user. The derivation of the query, the querying of the database and retrieval of relevant matching records therefrom, and the dynamic creation of HTML or like language pages can all be performed by the implementing program, and the creation of such a program is not beyond one of ordinary skill in the art scripting languages commonly embedded in HTML and like languages pages.

Once matching records have been extracted from the database, there are a number of options as to how the negotiation between the user having entered an appointment item offering the service and that user requesting same is continued. For example, the user requesting the service may be offered with a link to e-mail the user providing the service, or alternatively an anonymous system of communication may be initiated, such as a chat room, or furthermore a down payment may be required in advance from the user requesting the service.

Of course standard methods of communication are envisaged, and the user requesting the service who is provided with offers of the service from one or more service providers may request further information regarding a particular user offering a service. For example, clicking a link dynamically created on a web page and identifying one particular offer of a service will result in the further extraction of information concerning the particular offer, such as the users contact details, e.g. address, telephone and fax numbers, e-mail and web site addresses.

1. A computer sever-based process for matching users of a messaging system requiring a particular service to those users of the same messaging system who have identified themselves as being capable of providing such a service, said users requiring a service being required to create an item in the messaging system including descriptive textual information concerning the service required and one or more proposed times and dates when that service would ideally be required, said service providers being required to create items including descriptive textual information concerning the service provided and a plurality of times when said service is capable of being provided, wherein the process includes the steps of
deriving a query string from the textual and time and date information entered by the user requiring a service
using said query string to query the messaging system database to extract relevant records identifying users offering a service of the type described and available at the relevant time and date
automatically returning the information retrieved from the database to the user requiring a service with information identifying the said users offering said service.

2. A process according to claim 1 wherein the messaging system is provided on one or more servers of a MSP.

3. A process according to claim 2 wherein the creation of items by users both requiring and offering a service is effected over a remote dial-up connection to said MSP.

4. A process according to claim 1 wherein the items created by users are appointment items which automatically require a selection to be made by the user of the relevant start and end times and dates of the particular appointment.

5. A process according to claim 4 or any claim dependent thereon wherein users creating appointment items using the system are required to make a selection of whether a service is being sought or offered before the appointment item is created in the MSP messaging system database.

6. A process according to claim 1 wherein the query is performed on a subset of the messaging system database, said subset being defined by the criterion of appointments which relate only to the supply of services.

7. A process according to claim 1 wherein additional criteria are included in the derived query, said additional criteria being one or more of date, time, cost, location, gender, age, and common interests.

8. A process according to claim 1 wherein the query is derived and conducted on the underlying system database immediately on creation of the appointment item, and information retrieved by said query is displayed on a subsequently dynamically created HTML or like language page.

9. A process according to claim 1 wherein the appointment item indicating the type of service required and ideal times therefor is created on, and information identifying users offering a service is returned to, a mobile telecommunications device having a calendaring function programmatically or otherwise provided thereon and capable of transmitting and receiving information to and from a computer network on which the messaging service is executing.

10. A process according to claim 9 wherein the means of transmitting and receiving information used by said mobile telecommunications device is selected from SMS (Short Message Service), WAP (Wireless Application Protocol), or iMODE.

11. A process according to 10 wherein the mobile telecommunications device is capable of communicating directly with the messaging system.
